(19) United States
(12) Patent Application Publication
(10) Pub. No.: US 2005/0270908 A1
(43) Pub. Date: Dec. 8, 2005

(54) Device and method for testing the leak-tightness of a timepiece case

(75) Inventor: Francois Gueissaz, Wavre (CH)

Correspondence Address: GRIFFIN & SZIPL, PC, SUITE PH-1, 2300 NINTH STREET, SOUTH, ARLINGTON, VA, 22204, US

(73) Assignee: Asulab S.A., Marin (CH)

(21) Appl. No.: 10/522,895

(22) PCT Filed: Aug. 6, 2003
(86) PCT No.: PCT/EP03/08672

§ 371 Date: Feb. 1, 2005

(30) Foreign Application Priority Data
Aug. 9, 2002 (EP) 02078340.3

(51) Int. Cl. G04B 47/06

(52) U.S. Cl. 368/11

(57) ABSTRACT

The present invention concerns a device for monitoring the water resistance of a case (2) of an electronic timepiece (1) including a time base (42) for generating a standard frequency signal and a central processing unit (44) for determining the time from the standard signal, characterized in that it includes an electronic sensor (32) capable of measuring fluctuations in the concentration of a gas in the atmosphere contained in the case (2), the results of the measurement carried out by the electronic sensor (32) being processed by the central processing unit (44) which, in response to the measurement signal, emits, if necessary, an acoustic or visual alarm.

The present invention concerns a device for ensuring that a timepiece case is water resistant or sealed as regards the exterior. The present invention also concerns a method for checking the water resistance or sealing of such a case.

It has already been proposed to have a prevailing pressure inside a watchcase greater than the atmospheric pressure, so as to prevent a higher external pressure than the pressure in the case causing penetration of water, steam, gas or dust into the case (Swiss Patent No. 312740). Thus, the case is provided with a valve allowing an inert gas to be forced therein at a pressure of 1.1 to 1.5 atmosphere and a manometer allowing the person wearing the watch to know the pressure prevailing inside the case.

A manometer is however a complicated, delicate and expensive instrument which, if the sealing device of the watchcase fails, is liable to be damaged, as is the movement, which considerably increases reconditioning expenses.

In order to overcome these problems, it has been proposed (Swiss Patent No. 544959) to replace the manometer by a device that is also for checking the excessive pressure in a watchcase, this device including a bistable elastically deformable membrane, separating the case in an airtight manner from an enclosed space in which a different pressure prevails, and means for making one or other of the two stable states of the membrane visible to the user.

A device of the type described hereinbefore has the advantage of being relatively simple and quite robust, and of being less expensive than a manometer. However, such a device has the drawback of providing all or nothing type information comparable to that provided by a warning light for example. Thus, the device will only pass from its first to its second stable state in which it indicates to the person wearing the watch that the latter has a water resistance problem, when the excessive pressure inside the watchcase has dropped by a predetermined value. Thus, it is quite possible for the watch to have water resistance problems, but for the excessive pressure prevailing therein not to have reached the threshold value necessary to trigger the device checking the water resistance quality. The movement can thus be damaged unbeknownst to the person wearing the watch. Moreover, the inert gas has to be forced into the case with a determined pressure higher than the trigger threshold of the checking device, which requires suitable tools that not all horologists are likely to have. Finally, the measures carried out by such a device can be erroneous because of ambient temperature variations which affect the pressure of the air contained in the case.

It is an object of the present invention to overcome the aforementioned drawbacks in addition to others by proposing a device for monitoring the water resistance of a watchcase which enables the user to be warned as soon as the latter starts to have water resistance defects.

The present invention therefore concerns a device for monitoring a case of an electronic timepiece including a time base for generating a standard frequency signal and a central processing unit for determining the time from the standard signal, characterized in that it includes an electronic sensor capable of measuring fluctuations in the concentration of a gas in the confined atmosphere of the case, the results of the measurement carried out by the electronic sensor being processed by the central processing unit, which, in response to the measurement signal, emits, if necessary, an acoustic or visual warning signal.

Owing to these features, the present invention provides a device for instantaneously warning the person wearing the watch of a water resistance defect in his watchcase. In fact, as soon as the watch has a water resistance defect, this causes a gaseous exchange between the surrounding air and the atmosphere contained in the watchcase and causes a concomitant decrease in the concentration of gas in the atmosphere contained in said case, a decrease which is detected by the sensor. Quickly warned of the loss of water resistance of his watch, the user can take it to his horologist who will be able to place it under a vacuum bell in order to test it and repair it if necessary. The risk of the watch movement being damaged is thus greatly reduced.

Another advantage of the present invention lies in the fact that the gas sensor operates in association with the electronic means of the watch, using these means to generate, if necessary, an acoustic or visual alarm. It is not, therefore, necessary to house additional electronic components in the watchcase, which allows substantial savings to be achieved in terms of component costs and assembly time, and space is also saved in the watchcase.

According to a complementary feature of the invention, the gas sensor includes a differential measuring bridge. This type of circuit is reliable, compact and consumes less energy since it is only switched on for brief moments at regular time intervals. Moreover, it does not include any moving members, which further increases its reliability.

According to another feature of the invention, the gas present in the atmosphere contained in the watchcase is an inert heavy gas having different thermal conductivity to that of the air like, for example, carbon dioxide. After observing a loss of water resistance of the watch and subsequent repair, the watch can be very easily reconditioned by a commercial horologist. In fact, while the watchcase is still open, one has only to introduce therein the inert heavy gas whose fluctuations in concentration have to be monitored. Thus, in the case of carbon dioxide, which is a gas that can easily be obtained in the form of an aerosol can, no specific tools are necessary. After having filled the case with gas, completely or partially, one only has to seal the latter without having to worry about the concentration of said gas insofar as the device according to the invention uses relative concentration values and not absolute values.

The use of an inert gas has other advantages. Thus, because of its neutrality, it cannot react with the watch components, such that variations in the concentration thereof in the confined atmosphere of the case faithfully reflect the gaseous exchanges occurring between the case and the ambient air. Of course, the inert gas selected must not be toxic or widespread in the air, i.e. the concentration thereof in the case must be higher than its concentration in the air.

According to a variant, the inert gas can be forced into the case via a valve. This variant proves particularly advantageous when one wishes to force an inert gas that is lighter than air into the watchcase, such as helium. In fact, it would not be possible to fill the case with such an inert light gas simply by opening the case and filling it using an aerosol can, since the gas would escape. Moreover, the thermal conductivity coefficient of helium is in a ratio of ten with respect to that of the ambient air, which allows increased detection sensitivity. Moreover, a light gas such as helium diffuses more easily, which further contributes to reinforcing detection sensitivity.

The present invention also concerns a method of monitoring the water resistance of a timepiece case, this method being characterized in that it includes the steps consisting of:
introducing a gas with an initial concentration into the confined atmosphere of the case;
measuring the initial concentration of said gas;
continuously or intermittently measuring the concentration of the gas, and
generating an alarm when the measured gas concentration is different from the initial concentration of said gas or when the leak rate exceeds a predetermined value.

Other features and advantages of the present invention will appear more clearly from the following detailed description of the monitoring device according to the invention, this example being given purely by way of non-limiting illustration, in conjunction with the annexed drawing, in which:

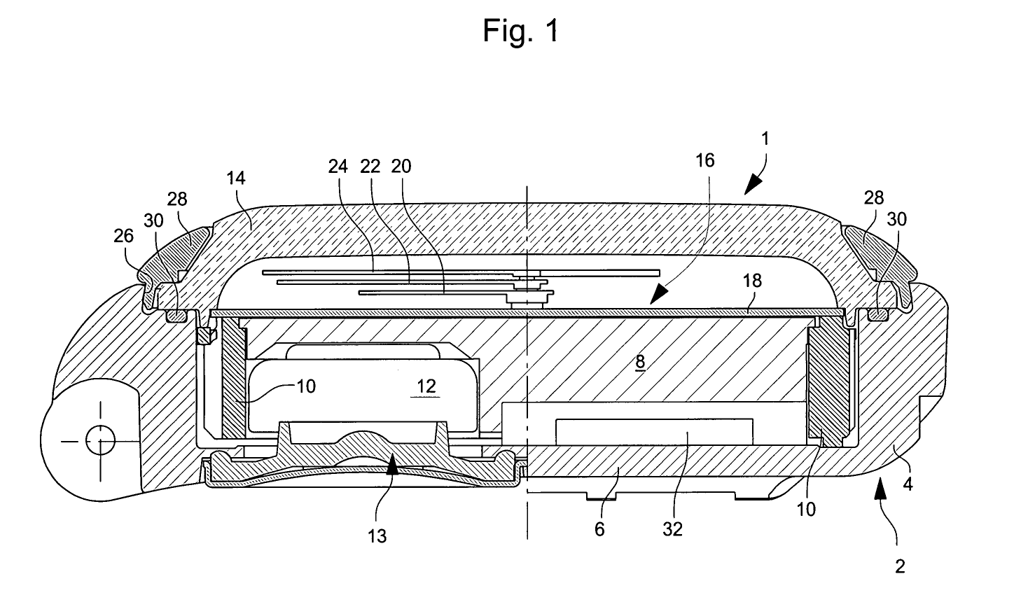

FIG. 1 is a cross-section of a wristwatch fitted with the water resistance monitoring device according to the invention;

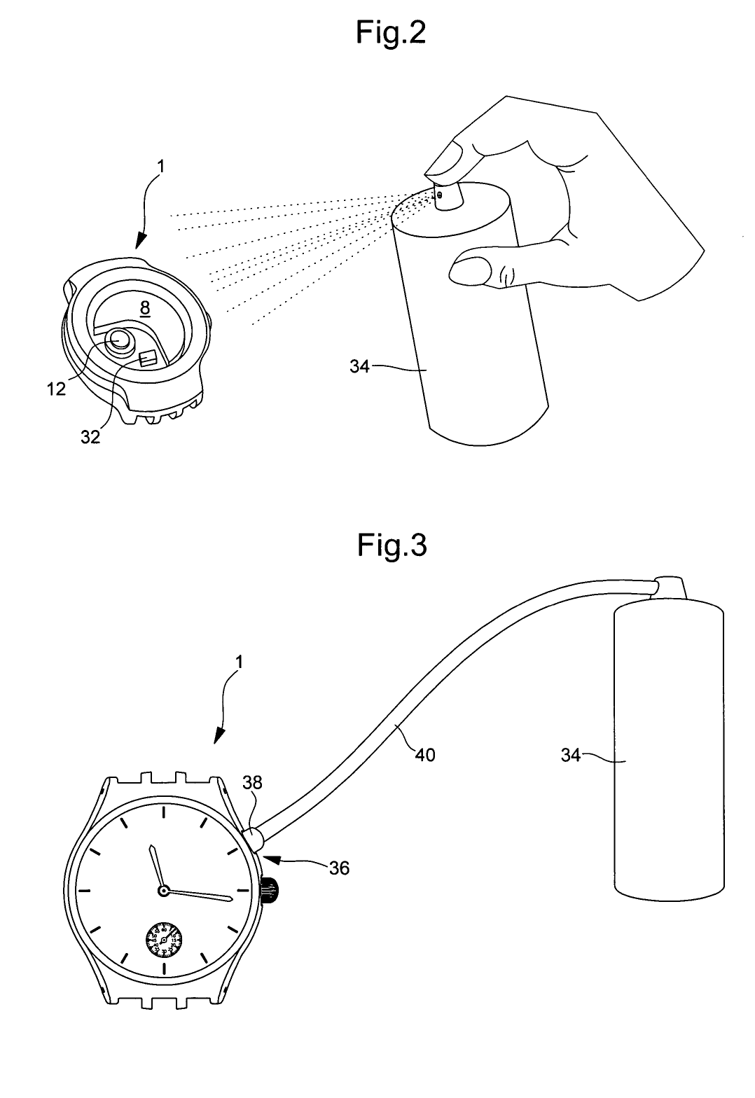

FIG. 2 is a view of the watchcase shown in FIG. 1 at the moment when it is filled with gas using an aerosol can;

FIG. 3 is a view of a watch fitted with a valve for forcing a gas into the watchcase, and

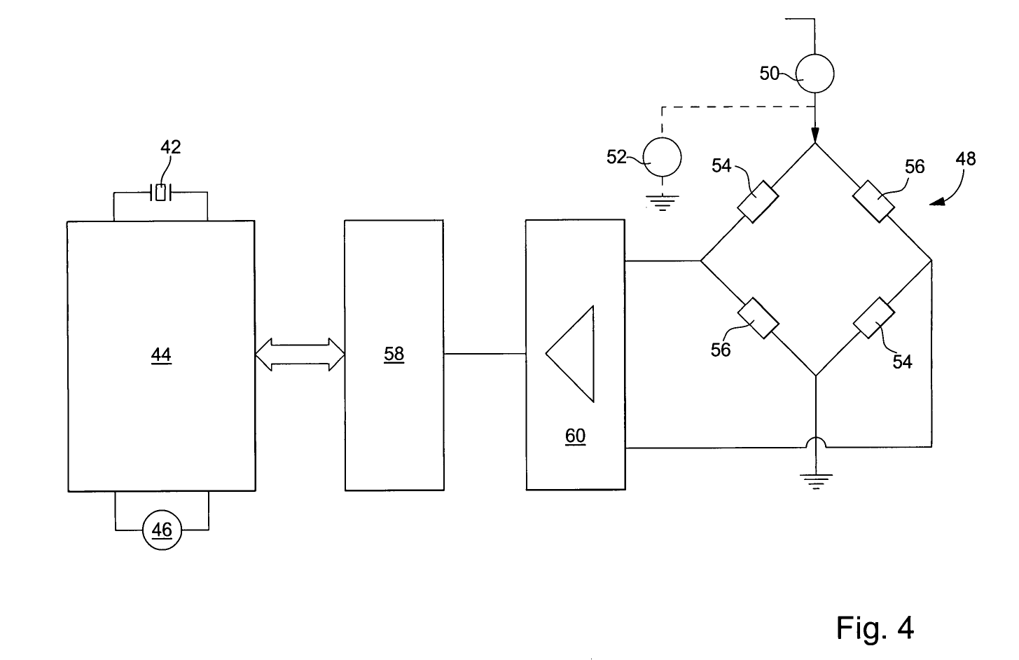

FIG. 4 is an electronic diagram of the gas sensor and the central processing unit of the watch.

The present invention proceeds from the general inventive idea that consists in measuring fluctuations in the concentration of a gas in the atmosphere contained in the watchcase. As soon as a decrease in the concentration of gas is detected, an alarm is generated in order to warn the person wearing the watch that the latter has a water resistance defect. Compared to the known solutions of the prior art which consist, mostly, in establishing excessive pressure in the watchcase and monitoring any decrease in such excessive pressure, the present invention has the main advantage of not forming an all or nothing type system which only provides information when the parameter being monitored reaches a threshold trigger value, but conversely, it provides an extremely sensitive system which will warn the person wearing the watch as soon as the latter starts to show signs of loss of water resistance. Moreover, the system according to the invention measures a relative value and not an absolute value. It is not, therefore, necessary to fix the initial concentration of gas at a determined value, since only the value of this initial concentration has to be known. Finally, the device according to the invention is of the passive type, such that it does not include any moving parts and is consequently very reliable.

The present invention will be described in conjunction with a timepiece of the wristwatch type. It goes without saying that the invention is not limited to such a watch and that it can equally be applied to measuring loss of water resistance for any type of timepiece.

FIG. 1 annexed to the present Patent Application is a cross-section of a timepiece fitted with a gas detection device according to the invention. Designated as a whole by the general numeral reference 1, this timepiece includes, in a conventional manner, a case 2 fitted with a middle part 4 and a back cover 6 which delimits the lower part of case 2. In the example shown in the drawing, back cover 6 is integral with middle part 4. It goes without saying however that the present invention applies in the same way to a non mono-shell case that includes a back cover distinct from the middle part. Case 2 can be made, for example, of a plastic material in accordance with well known injection techniques. The present invention is not limited, however, to the choice of such a material and case 2 could be made of any type of material suited to the requirements of the watchmaking industry such as, in particular, steel.

Timepiece 1 also includes a horometric movement 8 mounted in a casing ring 10. This movement 8 is supplied with current by an electric battery 12 which may, if necessary, be recharged when exhausted, or replaced. Battery 12, shown schematically in the drawing, is typically a button type battery. It can be housed in back cover 6 of watch 1. The lower face of battery 12, which forms one of the poles of the latter, is electrically connected to watch 1 earth, for example via a spring contact 13 fixed to back cover 6 of said watch 1. The other pole of battery 12 that is formed by its upper face is, in the usual manner, electrically connected to horometric movement 8.

In its upper part, case 2 is delimited by a glass 14 covering time information display means 16. In the example shown in the drawing, these display means 16 are formed of a dial 18 above which an hour hand 20, a minute hand 22 and a second hand 24 move. These are thus analogue time display means. They could also be digital display means formed by a liquid crystal cell.

Finally, case 2 includes on its upper periphery a notch 26 in which there is engaged a bezel 28, which secures glass 14 to case 2. Bezel 28 is fixedly mounted on case 2, for example by bonding or ultrasound welding or by being driven therein. Glass 14 is made water resistant with respect to case 2 owing to the use of a gasket 30 wedged between the glass and the case.

As can be seen in FIG. 1, timepiece 1 also includes a sensor 32 housed inside case 2. This sensor 32 is capable of detecting fluctuations in the concentration of a gas such as, for example, carbon dioxide, in the atmosphere contained in case 2. Sensor 32 is preferably of the electronic type, of small dimensions and consuming little energy. One example of such a sensor is formed by that marketed by the Microsens Product company under the reference MTCS 2200.

The operating principle of such a sensor is as follows. Electrical heating means have the role of keeping a thermally and electrically insulated membrane forming an integral part of the sensor at a predetermined reference temperature. The thermal conductivity of the atmosphere contained in the case varies as a function of fluctuations in the concentration of inert gas in said atmosphere, and more or less energy thus has to be provided to the heating means in order to keep the membrane at its reference temperature. Correspondence tables determine, as a function of the electrical energy provided, the concentration in the atmosphere of the inert gas used. In the case of carbon dioxide, its thermal conductivity is less than a third of that of the air, which allows variations in the concentration of this gas as low as 1% to be detected. In another embodiment, the thermal flux is measured between the heated membrane and a temperature sensor, separated from each other by the gas whose concentration fluctuations have to be measured.

When gas sensor 32 is to be used, the watch must first of all be filled with inert gas. In order to do this, two solutions can be envisaged. The first, which is the simplest, consists in opening case 2 of watch 1 and spraying the gas inside the latter. Thus, in the case of carbon dioxide, which is a gas that can easily be obtained in the form of an aerosol can 34 (see FIG. 2), no specific tools are necessary. After having filled case 2 with gas, the latter only needs to be sealed in a water resistant manner. According to a variant, it is also possible to fit watch 1 with a valve 36 (see FIG. 3) that opens via an external application pressure and which includes a tube 38 to which a pressurized gas supply conduit can be fitted.

As shown in FIG. 4, horometric movement 8 of watch 1 includes in a conventional manner a time base 42 for generating a standard frequency signal and a central processing unit 44 for determining the time from the standard signal and supplying drive pulses to a motor 46 which will drive hour hand 20, minute hand 22 and second hand 24 via a gear train that is not shown. According to a variant, central processing unit 44 could also supply electrical control signals to a liquid crystal display to display the time digitally.

According to a preferred embodiment of the invention, pressure sensor 32 includes a differential measuring bridge 48 which can be powered using a current generator 50 or voltage generator 52 and which is formed of four branches each including a resistor, respectively 54 and 56, and series connected. The resistors of the pair of branches which are mounted in parallel on the current source are equal, whereas the resistors 56 of the other pair of branches have a resistance that varies as a function of the concentration of inert gas in the atmosphere contained in case 2 of watch 1. When the concentration of gas decreases, the equilibrium is broken between the two pairs of branches, which creates a potential difference proportional to the concentration of inert gas. This potential difference is applied to the input of an analogue/digital converter 58 via a differential amplifier 60. Finally, the output of converter 58 is connected to one of the inputs of central processing unit 44 of watch 1.

If the watch is fitted with a liquid crystal display, central processing unit 44 could indicate the leak rate of watch 1 to its user. The leak rate is the ratio between a pressure difference expressed in millibars and a length of time expressed in seconds, the whole being multiplied by the volume expressed in litres from the watchcase. In practice, in order to calculate the leak rate, the central processing unit calculates the difference between the last two pressure measurements carried out then divides this result by the length of time that separates the moments at which the pressure measurements were carried out. The central processing unit then only has to multiply this ratio by a constant which represents the volume of the watchcase. The real value of the leak rate can be displayed on the liquid crystal display cell. One can also choose to enter into the central unit memory a nominal value which represents the maximum admissible leak rate by the watch, and to express the value of the leak rate measured as a percentage of the nominal value. Likewise, for increased precision, the central processing unit can calculate a mean leak rate for several pairs of pressure values measured in the past. The advantage of calculating the leak rate lies in the fact that the latter can have an exaggerated value whereas the concentration of gas in the atmosphere contained in the watchcase has not yet passed below the critical threshold beyond which the alarm is triggered. The user could thus, himself, check the water resistance quality of his watch 1 and decide whether it needs to be taken back to the horologist to be repaired.

Once the gas has been introduced into case 2, sensor 32 carries out a measurement of the initial concentration of the gas, then carries out subsequent measurements continuously or intermittently. As soon as the sensor detects a variation in the concentration of inert gas in the atmosphere contained in the case higher than a predetermined value, it generates an alarm. In fact, if the concentration of inert gas varies, this means that air has penetrated the case from the exterior of the latter. The alarm can be of the visual type in the form of a message or a symbol on a liquid crystal screen. The sensor can also command a warning light to be switched on or even an acoustic signal to be emitted. From then on, the person wearing watch 1 is warned that the latter has a water resistance defect and that it should be taken to a horologist for repair. Since the user is quickly informed, the risk of the watch movement being deteriorated is greatly limited.

It goes without saying that the present invention is not limited to the embodiments that have just been described and that various modifications and simple variants can be envisaged without departing from the scope of the invention. In particular, one could envisage the gas sensor carrying out an ambient temperature measurement before measuring the desired concentration of gas. Indeed, a timepiece is typically intended to operate in a temperature range comprised between −20° C. and +70° C. It will be understood that such temperature differences affect the pressure inside the case. By measuring the ambient temperature beforehand, the sensor can take account of the result of this measurement to correct the pressure measurement that it will subsequently carry out.

1-12. (canceled)

13. A device for monitoring the water resistance of a case of an electronic timepiece including a time base for generating a standard frequency signal and a central processing unit for determining the time from the standard signal, wherein it includes an electronic sensor capable of measuring fluctuations in the concentration of a gas in the atmosphere contained in the case, the results of the measurement carried out by the electronic sensor being processed by the central processing unit which, in response to the measurement signal, emits, if necessary, an acoustic or visual warning alarm.

14. The device according to claim 13, wherein the sensor includes means for measuring said concentration continuously or intermittently and generating an alarm signal as soon as it detects a fluctuation in the value of the concentration of the gas greater than a predetermined value.

15. The device according to claim 14, wherein the electronic sensor includes a differential measuring bridge.

16. The device according to claim 13, wherein the enclosed space is provided with a valve for forcing gas therein.

17. The device according to claim 13, wherein the sensor includes electrical heating means whose role is to keep a thermally and electrically insulated membrane at a constant temperature.

18. A method of monitoring the water resistance of a case of a timepiece, wherein it includes the steps of:
introducing a gas with an initial concentration into the atmosphere contained in the case;
measuring the initial concentration of gas;
continuously or intermittently measuring the concentration of gas, and
generating an alarm when the measured concentration of gas is different from the initial concentration of said gas or when the leak rate exceeds a predetermined value.

19. The method according to claim 18, wherein before measuring the concentration of gas, the ambient temperature is measured.

20. The method according to claim 18, wherein the case is filled with gas by opening the latter, filling it with gas, then sealing it in a water resistant manner.

21. The method according to claim 18, wherein the enclosed space is filled with gas via a valve.

22. The method according to claim 18, wherein the gas present in the atmosphere of the enclosed case is an inert gas.

23. The method according to claim 22, wherein the concentration of inert gas in the atmosphere of the enclosed case is less than its concentration in the ambient air.

24. The method according to claim 22, wherein the inert gas is carbon dioxide or helium.

25. The method according to claim 23, wherein the inert gas is carbon dioxide or helium.
